(19) United States
(12) Patent Application Publication
(10) Pub. No.: US 2024/0378681 A1
(43) Pub. Date: Nov. 14, 2024

(54) SYSTEM AND METHOD FOR COLLABORATIVE DIGITAL MEDIA SHARING IN AN EVENT ECOSYSTEM

(71) Applicant: Amnon Filippi, New York, NY (US)

(72) Inventor: Amnon Filippi, New York, NY (US)

(21) Appl. No.: 18/631,648

(22) Filed: Apr. 10, 2024

Related U.S. Application Data
(60) Provisional application No. 63/458,645, filed on Apr. 11, 2023.

(51) Int. Cl. G06Q 50/00; G06F 21/10; G06K 19/06; G11B 27/031

(52) U.S. Cl. CPC G06Q 50/01; G06F 21/1066; G06K 19/06037; G11B 27/031

(57) ABSTRACT

A system and method for the distribution and editing of photos, files, and other documents in a shared, collaborative social network for event ecosystems. The present invention allows users to scan a QR code to gain access to shared albums from but not limited to events and gatherings. Users may view attendees and their uploads, which are encrypted and secured on a cloud network. A vetting system is incorporated within the system to ensure individual participants consent to the circulation of event photographs. A unique ID is associated with each file and user so that the circulation of images may be monitored, and a notification tab maintains a record of all interactions within event gallery spaces among friends and gathering attendees.

### CROSS REFERENCE TO RELATED APPLICATIONS

This application claims the benefit of U.S. Provisional Patent Application Ser. No. 63/458,645, filed Apr. 11, 2023, the contents of which are incorporated herein by reference in their entirety.

### BACKGROUND OF THE INVENTION

Image and video sharing has existed for decades now, graduating from single-file upload platforms such as Photobucket and Flickr to drop-share formats, such as Airdrop, wherein files can be shared without loading them directly on to another device. While image and video sharing has developed immensely, there are still massive discrepancies. For example, sharing photos and videos through Airdrop features limitations such as requiring an IOS device. Uploading files on to DropBox or other image-sharing websites can take a lot of time and space on a device. Moreover, uploading files on to another platform removes an element of control from the photo and video sharing process.

In addition to the deficiencies stated above, there has yet to exist a photo and video sharing platform wherein these digital media files can simultaneously be shared, edited, distributed, and then monitored in a group setting. These features are especially beneficial for large events and gatherings wherein some individuals want to reject consent to a particular set of images or videos from being distributed and remove themselves from the photograph or video and view a list of the individuals who distributed said photograph and video. This helps eliminate the burden of unappealing or confidential images and videos from circulating on the internet and provide more creative control over their photo and video sharing experiences.

Moreover, the present invention allows individuals to track digital media distribution, thus efficiently finding the source of digital media leaks. These digital media forms can either be photos, or videos, or even confidential documents in some instances. The present invention also accommodates an audience in an event-based ecosystem, which helps connect users in a more intimate fashion and provide a network wherein the sharing of images and videos are more accessible to all attendees, indiscriminately, no matter what devices they own.

### SUMMARY OF THE INVENTION

The present pertains relates to a system and method for collaborative digital media sharing. Digital media encompasses all pieces of digital media that can be stored within a device, such as a photo, video, .gif, .png, .jpeg, .pdf or any other type of digital media format. In the preferred embodiment, the collaborative digital media sharing is an image and video sharing platform and is utilized at an event or multi-person gathering wherein individuals may capture and distribute photos and videos. Users are provided with a QR code that can grant them access to an event gallery.

Each event gallery has a host, and the host may manage users by either adding them or removing them. The event host can feature images they wish to spotlight for all attendees and invite people to join their gallery. Attendees may save all the images, videos, and files by pressing a ‘Save All Images’ or ‘Save Gallery’ button or they may individually download them. The platform also offers a notification tab wherein users may view the activity of their friends, and the activity of each event gallery they are a part of. After a certain duration, which may be customized and adjusted by the event host, image, videos and files can no longer be uploaded.

Users may load images and videos by way of a cloud storage service or platform and share it with a list of all event and gathering attendees. The platform will provide a list of all individuals featured in each image or video, and in some embodiments, may utilize artificial intelligence to recognize specific attendees. Attendees will then be alerted of the visual tags associated with the digital media format and be given their own unique code in association with said digital media format, and upon download, will maintain a record of all actions with the digital media format. For example, if an image or video is edited to fix red eyes, or to crop a certain individual who does not consent to the image or video being distributed, the file index may update according to the changes.

In another embodiment of the present invention, users may not be able to screen capture any of the images and videos. This is to assure that individuals do not distribute screencaps or pieces of digital media when multiple subjects do not consent to it circulating. Users may digitally provide their consent to the distribution by verifying by way of a check mark or other signifier. In some embodiments, if multiple attendees do not consent to a piece of digital media, such as a photograph or video being distributed, they may, by way of either a poll, or the event host blocking it, lock it so that only the metadata can be seen. If an media is still somehow in circulation, the media form will have a unique code or identifier within it so that the source can be recognized. In addition to providing a unique code or identifier, the file within the platform will provide a history of when the digital media file was last viewed and by who.

The digital media sharing platform will utilize a cloud network that is operable on a multitude of mobile devices, without discrimination to make and model of their device.

In yet another embodiment of the invention, the system may comprise of each image or video being filtered to prevent spam-uploads to an event space if the filtration system is toggled on by an event host. By way of artificial intelligence, event hosts may select specific elements to autonomously filter—for example, if an event host wants to flag certain environment in an event space—artificial intelligence may recognize select articles of interest and flag an image or video accordingly. Then, the event host may choose to unflag an image and allow it to enter the event gallery stream or to discard it. The same process is adopted for specific geolocations flagged in an event space—if the event space's metadata corresponds with a flagged area, the image or video is filtered and only an event host can view it.

In an alternative embodiment of the disclosed invention, deep learning technology may be implemented to create realistic imagery of an event or to alter an event in the instance that an authorized host wishes to remove an undesirable element from a video that is in circulation or implement a new element into a video. This can include adding unique facial filters to videos or simply restructuring other elements of a video to alter them.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 is an exemplary QR code to access event spaces and galleries, and the introductory pages when the platform is accessed.

FIG. 2 is an exemplary login page, password recovery page and sign-up page.

FIG. 3 is the platform's instructional and introductory page.

FIG. 4 is an overview of the platform's home page, “Start A Party” module, and event page.

FIG. 5 is a more intricate view of an event gallery, images uploaded on to an event space, an image upload page, and the QR code for inviting attendees to join the party.

FIG. 6 details past events module, a favorites module and an event module which allows attendees to download all images at once.

FIG. 7 is a user's notification page which shows activity from the attendees of various events, the profile overview, which is editable, and the subscription and service packages the platform offers.

FIG. 8 is a diagram depicting the platform's web service infrastructure.

FIG. 9 is a depiction of the platform's web services, as well as the components of an exemplary operating environment in which embodiments of the present invention may be implemented.

FIG. 10 is an illustration of a multi-server room and the various locations in which other pertinent server rooms may exist.

FIG. 11 is a diagram outlining the web services incorporated with server-client communication.

FIG. 12 is a diagram of the flow of access between the platform of the present invention and the web services client via cloud software tools.

FIG. 13 is a diagram of an example of the cloud storage organization in which the web services accesses and retrieves user data as objects in buckets within a cloud storage space.

FIG. 14 is a line diagram illustrating a decentralized network.

FIG. 15 is a line diagram illustrating a distributed network.

FIG. 16 is an illustration depicting an exemplary operating environment including one or more user computers, computing devices, or processing devices, which can be used to operate a client, such as a dedicated application, web browser is shown.

FIG. 17 is another illustration depicting an exemplary operating environment including a computer system with various elements as shown.

FIG. 18 is a diagram depicting the video upload feature of the present invention.

### DETAILED DESCRIPTION OF THE PREFERRED EMBODIMENT

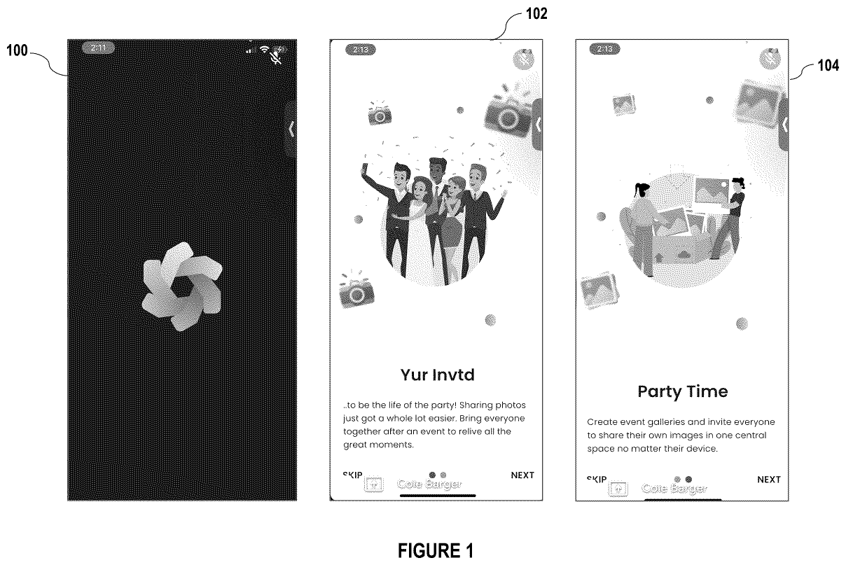

FIG. 1 is an exemplary opening screen for the application, which provides an introduction on the platform and its services. The introductory pages may be skipped if a user wishes to immediately view the home page.

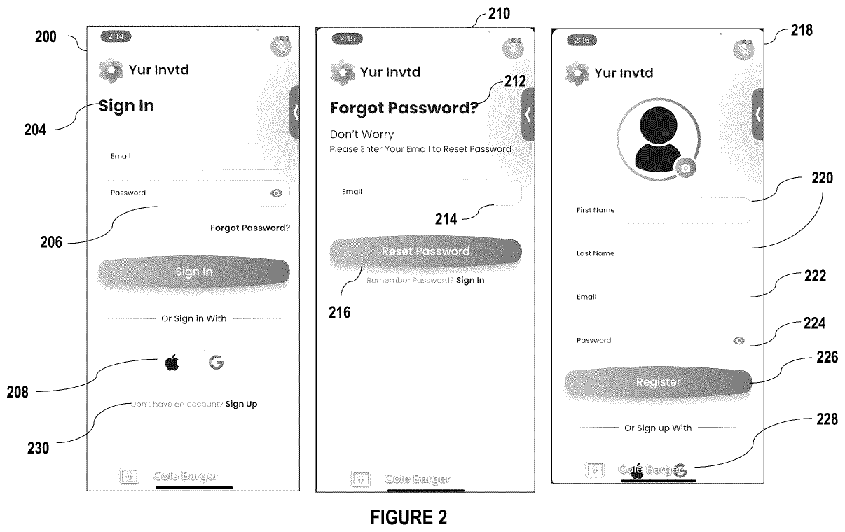

FIG. 2 is an exemplary login page 200, password recovery page 210 and sign-up page 218. Users may sign in 204 by way of the login page 200 and enter their password credentials 206 to sign in. An alternative login is available by way of an Apple or Google ID 208. Users may also be prompted to sign up 230 if they don't have an account. If a user forgets their password 212, they can enter the password recovery page 210. This will prompt them to enter their email 214 and reset their password 216. A sign-up page 218 features fillable boxes for users to enter their first and last name 220 and email address 222 alongside their desired password 224. Then, they may register 226. If a user wishes to use an alternative sign up, they may, by way of Apple or Google accounts 228.

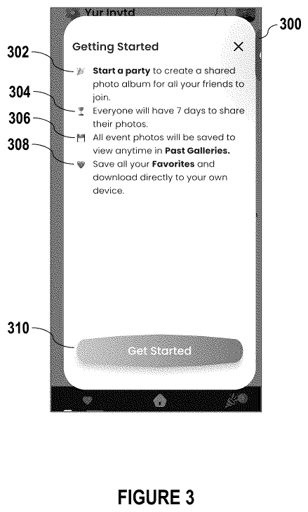

FIG. 3 is the platform's instructional and introductory page 300. The introductory page 300 goes over a series of actions for users and the purpose of those actions. Users may start a party 302 and create a shared album. A time frame for uploads is disclosed 304. Event photos are saved to view anytime in the Past Galleries module 306 and all favorited images can be directly downloaded on to the device 308. When a user wishes to continue, they can press the Get Started button 310 and begin photo sharing.

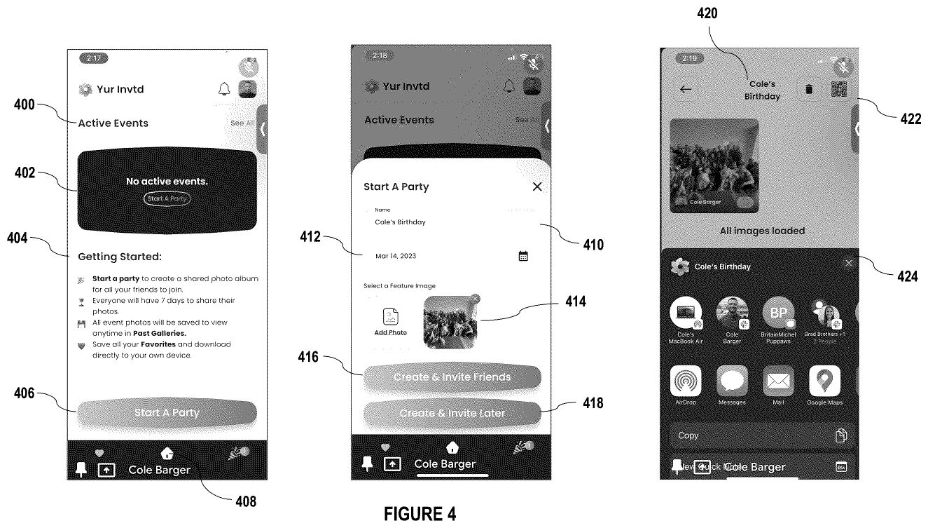

FIG. 4 is an overview of the platform's home page 400 Start A Party module 410, and event page 422. On the platform's home page 408 users can view active events 400 which showcase any active event galleries. The home page 408 also has the Getting Started instructional module which details steps on how to create a shared album, the time limit to upload on to said album, and the actions a user can take regarding their photo album. Once ca user clicks the Start a Party button 406, they are prompted to the Start a Party module 410 where they can add a title for the event, and choose the event date, as well as a feature image 414 for attendees to view. Then, a user—or a host—can create the album and invite friends 415 or create the event and invite others later 418. The event page 422 allows individuals to view all loaded images of an event in the event space 420 which in this illustration is a birthday. Users are able to share the album 424 with their various contacts. The formats will also vary based on the device they use, but all devices are compatible with the platform.

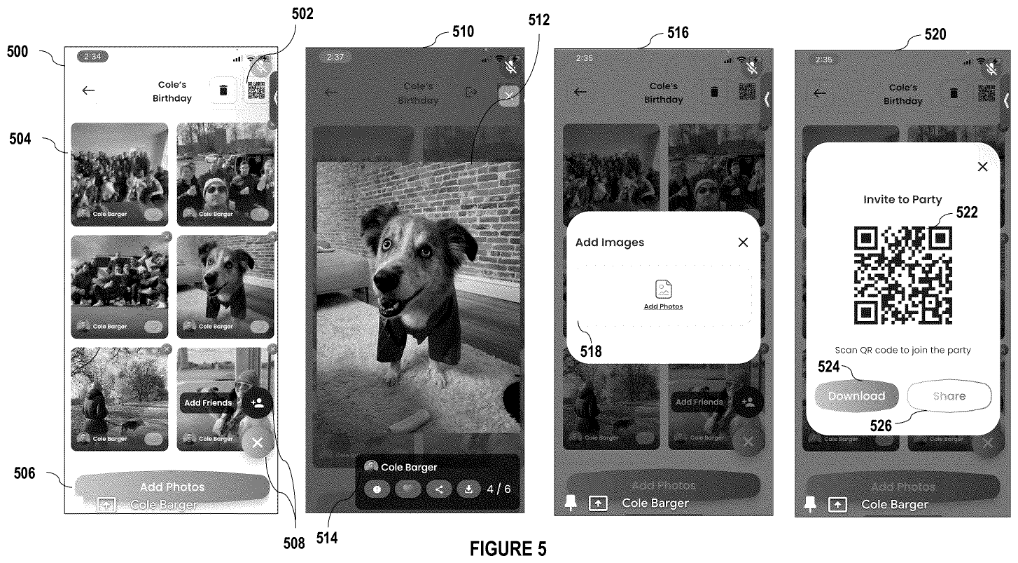

FIG. 5 is a more intricate view of an event gallery 500, images uploaded on to an event space 512, an image upload page 516, and the QR code 522 for inviting attendees to join the party. The event gallery 500 features the gallery images 504 and a QR code 502 which may be loaded and shared. Users may also add photos 506 to the gallery and add friends to the gallery 508. In this example the selected gallery image features a dog 512 in the module 510. In addition, users may also like, share and download photos 514 as they scroll. Users can also upload images 518 in the Add Images module 516. A QR code pop up 520 shows a QR code 522 to invite people to the party. They can scan the QR code 522, download it 524 or share it to others 526.

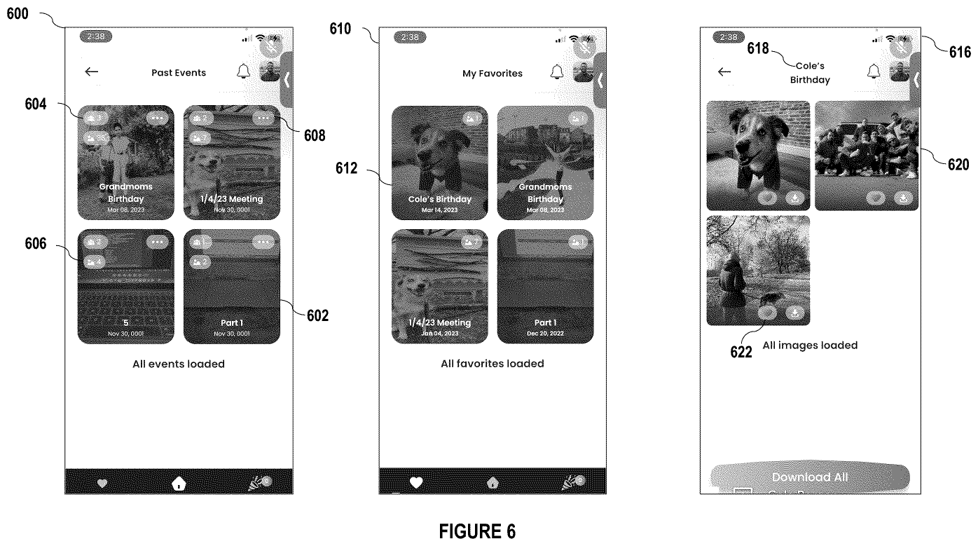

FIG. 6 details past events module 600, a favorites module 610 and an event module 618 which allows attendees to download all images at once. The past events module 600 displays the number of attendees and individuals in a shared album 602, the number of photos 606 in each shared album 602 and a clickable element 608 that allow users to view more actions. The favorites module 610 show all favorited 612 albums. When a specific album is clicked 618 then the album module is visible 616. Images and albums can be favorited 622, and all images may be downloaded at once, if a user desires.

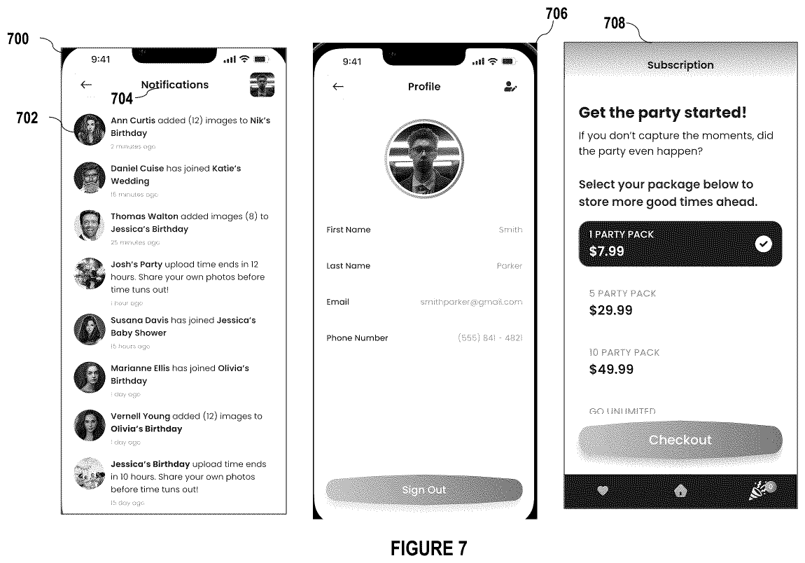

FIG. 7 is a user's notification page 700 which shows activity from the attendees of various events 702, the profile overview 206, which is editable, and the subscription and service packages the platform offers 708. Notifications 704 include whenever a friend or attendee adds an image to the shared album, or when they join an album.

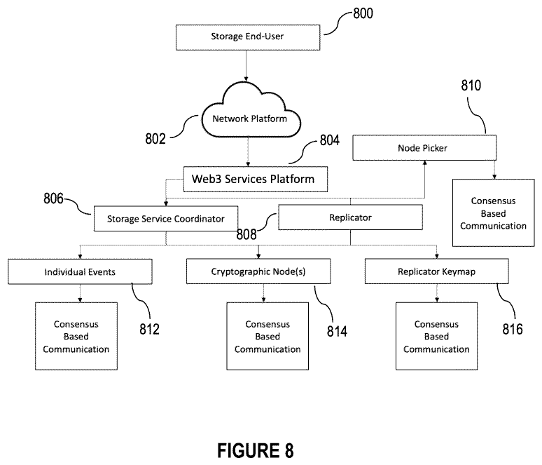

FIG. 8 is a diagram showing the communication between the storage end users, the network platform and the various elements that help effectuate operations. The storage end user communicates and relays various pertinent bits of data to the network platform. The network platform operates on the web service platform, which features a storage service coordinator and replicator. Each of these services utilize a node picker which helps establish consensus-based communication. The storage service coordinator maintains and records individual events and cryptographic nodes, or keys that are used for operations. The replicator has its own keymap which generates consensus-based communication, alongside the cryptographic nodes and individual events.

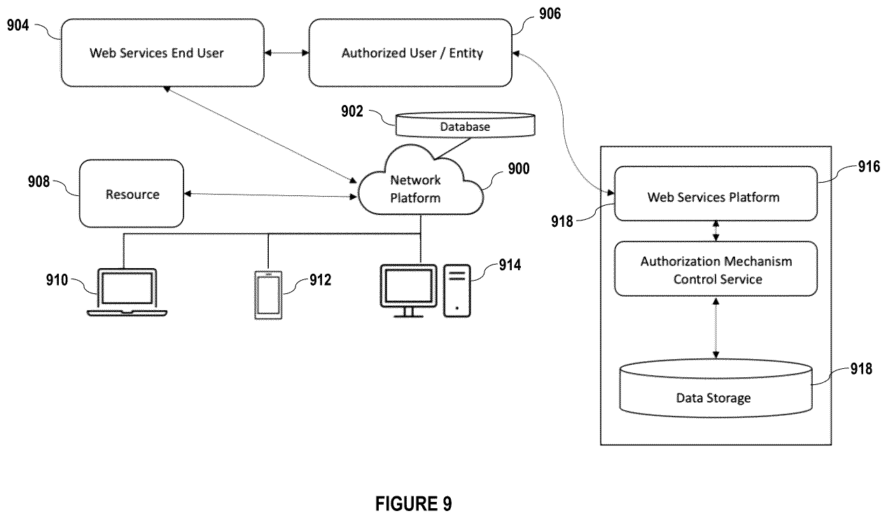

FIG. 9 is a diagram showing the web services of the platform and system. The platform and system are all components of an exemplary operating environment in which embodiments of the present invention may be implemented. The system can include one or more user computers, computing devices, or processing devices which can be used to operate a client, such as a dedicated application, web browser, etc. The user computers can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers may also have any of a variety of applications, including one or more development systems, database client and/or server applications, and Web browser applications. Alternatively, the user computers may be any other electronic device, such as a thin-client computer, Internet-enabled gaming system, and/or personal messaging device, capable of communicating via a network (e.g., the network described below) and/or displaying and navigating Web pages or other types of electronic documents. Although the exemplary system is shown with four user computers, any number of user computers may be supported.

In most embodiments, the system includes some type of network. The network can be any type of network familiar to those skilled in the art that can support data communications using any of a variety of commercially available protocols, including without limitation TCP/IP, SNA, IPX, AppleTalk, and the like. Merely by way of example, the network can be a local area network (“LAN”), such as an Ethernet network, a Token-Ring network and/or the like; a wide-area network; a virtual network, including without limitation a virtual private network (“VPN”); the Internet; an intranet; and extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, WiMAX, WiFi, CDMA 2000, WCDMA, the Bluetooth protocol known in the art, and/or any other wireless protocol); and/or any combination of these and/or other networks.

The system may also include one or more server computers which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers may be dedicated to running applications, such as a business application, a Web server, application server, etc. Such servers may be used to process requests from user computers. The applications can also include any number of applications for controlling access to resources of the servers.

The web server can be running an operating system including any of those discussed above, as well as any commercially available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers. As one example, a server may execute one or more Web applications. The Web application may be implemented as one or more scripts or programs written in any programming language, such as Java.RTM., C, C#, or C++, and/or any scripting language, such as Perl, Python, or TCL, as well as combinations of any programming/scripting languages. The server(s) may also include database servers, including without limitation those commercially available from Oracle.RTM., Microsoft.RTM., Sybase.RTM., IBM.RTM. and the like, which can process requests from database clients running on a user computer.

End users, or users that are viewing and using the network platform, all contribute data to the cloud. A web service platform helps secure that data and maintain the service's functionalities. Only authorized users and entities can authorize or unauthorize content and monitor data stored within the web service. The platform's web services help maintain the operations of elements managed by the storage system.

The system may also include one or more databases. The database(s) may reside in a variety of locations. By way of example, a database 620 may reside on a storage medium local to (and/or resident in) one or more of the computers. Alternatively, it may be remote from any or all of the computers, and/or in communication (e.g., via the network) with one or more of these. In a particular set of embodiments, the database may reside in a storage-area network (“SAN”) familiar to those skilled in the art. Similarly, any necessary files for performing the functions attributed to the computers may be stored locally on the respective computer and/or remotely, as appropriate. In one set of embodiments, the database may be a relational database, such as Oracle 10g, that is adapted to store, update, and retrieve data in response to SQL-formatted commands.

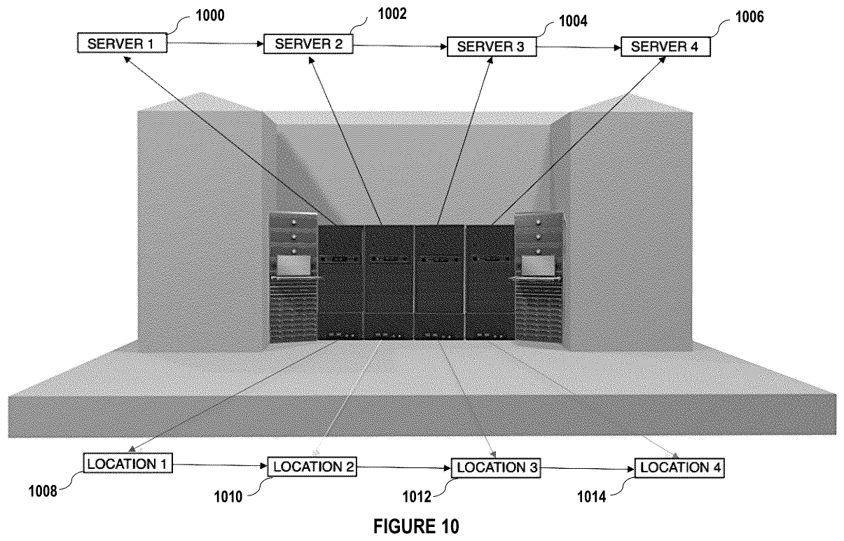

FIG. 10 is an illustration of server-to-server connections, within a server room and to other sever room locations. The web server undergoes an initialization process and features a database of wireless network data. Dependent on the service requested, the data may undergo processing. The servers actively attempt to retrieve the appropriate data to provide user input. Data may then be formatted, and with the appropriate authorizations, saved or restructured.

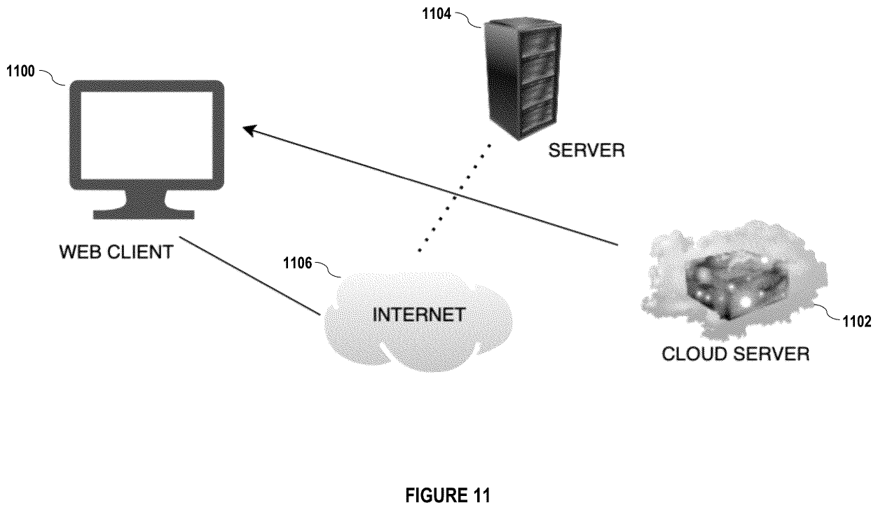

FIG. 11 is a diagram outlining the role of web services in the present invention. In accordance with the preferred embodiment, a web client interacts with the server ecosystem by way of a service connection, such as the internet, which then distributes data and pertinent information such as the web service platform to the cloud server and preliminary servers. This allows for data to be streamlined between the client and the server as well as cloud servers and other database systems. Communication between web services may be completed via Simple Object Access Protocol (SOAP) which allows multiple web service applications to communicate rapidly and efficiently and to provide data to the web client.

The infrastructure of the present invention also allows for the use of web services that enable interaction with and storage of data across devices. Specifically, these web services can allow for the use of cloud software tools and cloud-based data storage. Cloud software tools can be used to allow for increased user authentication and authorization checkpoints for data accessed between parties. The web service software aids in the transmission of data between entities while still maintaining secure access restrictions preventing any unauthorized access to the cloud data.

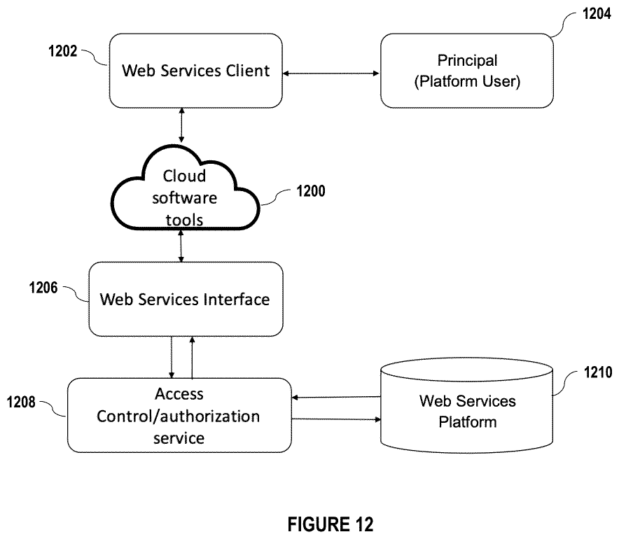

FIG. 12 is a diagram of the flow of access between the platform of the present invention and the web services client via cloud software tools. The principal or platform user accesses the web services client, which then transmits data via cloud software tools to the web services interface. Access control and authorization acts as a layer in order to access the web services platform by way of the web services interface.

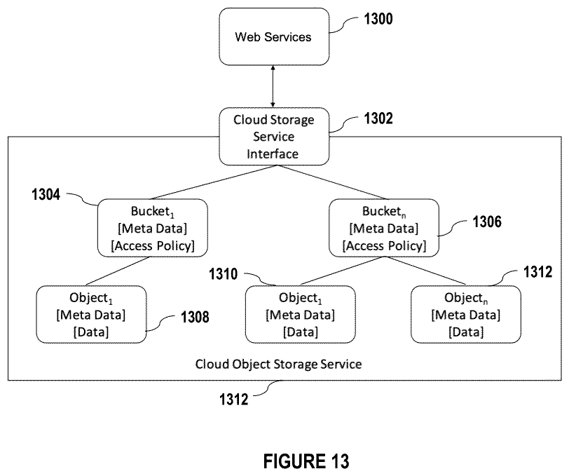

FIG. 13 is a diagram of an example of the cloud storage organization in which the web services accesses and retrieves user data as objects in buckets within a cloud storage space. The cloud storage service is a means of storing and protecting any amount of data for a range of use cases. A bucket is a container for objects stored in the cloud storage service, and objects consist of object data and metadata. The metadata is a set of name-value pairs that describe the object. These pairs include some default metadata, such as the date last modified, and standard HTTP metadata, such as Content-Type. You can also specify custom metadata at the time that the object is stored. Web services provide access to and from the cloud object storage service via the cloud storage service interface.

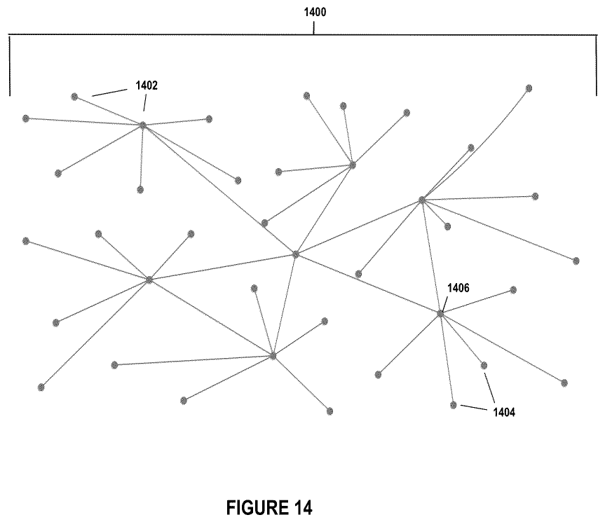

FIG. 14 is a line diagram illustrating a decentralized network. In accordance with the preferred embodiment of the present invention, the specific architecture of the network can be either decentralized or distributed. FIG. 14, generally represented by the numeral 1400, provides an illustrative diagram of the decentralized network. FIG. 14 depicts each node with a dot XX02 Under this system, each node is connected to at least one other node 1404. Only some nodes are connected to more than one node 1406.

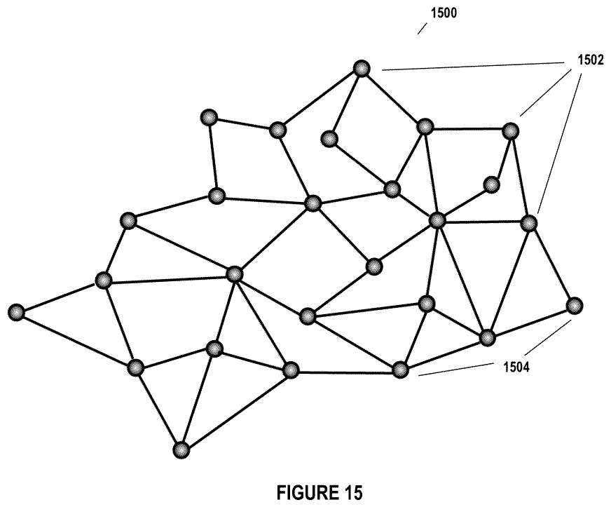

FIG. 15 is a line diagram illustrating a distributed network. For comparison purposes, FIG. 15, which is generally represented by the numeral 1500, illustrates a distributed network. Specifically, the illustration shows the interconnection of each node 1502 in a distributed decentralized network 1500. In accordance with the preferred embodiment of the present invention, each node 1502 in the distributed network 1500 is directly connected to at least two other nodes 1504. This allows each node 1502 to transact with at least one other node 1502 in the network. The present invention can be deployed on a centralized, decentralized, or distributed network.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provides services comprising receiving client update information from client devices and responding to client lookup requests from client devices. The plurality of registry servers in each of the plurality of registry groups provide the services using, at least in part, a quorum consensus protocol.

As another example, a method is provided for device discovery and communication using a distributed hierarchical registry. The method comprises broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

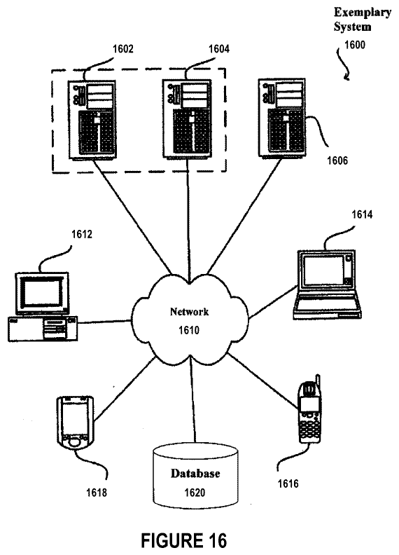

FIG. 16 is a block diagram illustrating components of an exemplary operating environment in which embodiments of the present invention may be implemented. The system 1600 can include one or more user computers, computing devices, or processing devices 1612, 1614, 1616, 1618, which can be used to operate a client, such as a dedicated application, web browser, etc. The user computers 1612, 1614, 1616, 1618 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 1612, 1614, 1616, 1618 may also have any of a variety of applications, including one or more development systems, database client and/or server applications, and Web browser applications. Alternatively, the user computers 1612, 1614, 1616, 1618 may be any other electronic device, such as a thin-client computer, Internet-enabled gaming system, and/or personal messaging device, capable of communicating via a network (e.g., the network 1610 described below) and/or displaying and navigating Web pages or other types of electronic documents. Although the exemplary system 1600 is shown with four user computers, any number of user computers may be supported.

In most embodiments, the system 1600 includes some type of network 1610. The network can be any type of network familiar to those skilled in the art that can support data communications using any of a variety of commercially available protocols, including without limitation TCP/IP, SNA, IPX, AppleTalk, and the like. Merely by way of example, the network 1610 can be a local area network (“LAN”), such as an Ethernet network, a Token-Ring network and/or the like; a wide-area network; a virtual network, including without limitation a virtual private network (“VPN”); the Internet; an intranet; and extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 1602, 1604, 1606 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 1606) may be dedicated to running applications, such as a business application, a Web server, application server, etc. Such servers may be used to process requests from user computers 1612, 1614, 1616, 1618. The applications can also include any number of applications for controlling access to resources of the servers 1602, 1604, 1606.

The Web server can be running an operating system including any of those discussed above, as well as any commercially available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 1612, 1614, 1616, 1618. As one example, a server may execute one or more Web applications. The Web application may be implemented as one or more scripts or programs written in any programming language, such as Java.RTM., C, C# or C++, and/or any scripting language, such as Perl, Python, or TCL, as well as combinations of any programming/scripting languages. The server(s) may also include database servers, including without limitation those commercially available from Oracle.RTM., Microsoft.RTM., Sybase.RTM., IBM.RTM. and the like, which can process requests from database clients running on a user computer 1612, 1614, 1616, 1618.

The system 1600 may also include one or more databases 1620. The database(s) 1620 may reside in a variety of locations. By way of example, a database 620 may reside on a storage medium local to (and/or resident in) one or more of the computers 1602, 1604, 1606, 1612, 1614, 1616, 1618. Alternatively, it may be remote from any or all of the computers 1602, 1604, 1606, 1612, 1614, 1616, 1618, and/or in communication (e.g., via the network 1610) with one or more of these. In a particular set of embodiments, the database 1620 may reside in a storage-area network (“SAN”) familiar to those skilled in the art. Similarly, any necessary files for performing the functions attributed to the computers 1602, 1604, 1606, 1612, 1614, 1616, 1618 may be stored locally on the respective computer and/or remotely, as appropriate. In one set of embodiments, the database 1620 may be a relational database, such as Oracle 10g, that is adapted to store, update, and retrieve data in response to SQL-formatted commands.

The computer system 1700 may also comprise software elements, shown as being currently located within a working memory 1718, including an operating system 1720 and/or other code 1722, such as an application program (which may be a client application, Web browser, mid-tier application, RDBMS, etc.). It should be appreciated that alternate embodiments of a computer system 1700 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

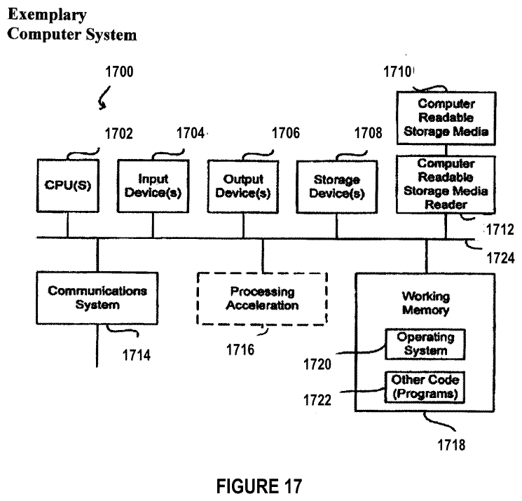

FIG. 17 further illustrates an environment where an on-demand distributed database service might be used. As illustrated in FIG. 17 user systems might interact via a network with an on-demand database. Some on-demand databases may store information from one or more records stored into tables of one or more distributed database images to form a database management system (DBMS). Accordingly, on-demand database and system will be used interchangeably herein. A database image may include one or more database objects. A relational database management system (RDMS) or the equivalent may execute storage and retrieval of information against the database object(s). Some on-demand database services may include an application platform that enables creation, managing and executing one or more applications developed by the provider of the on-demand database service, wherein users access the on-demand database service via user systems, or third-party application developers access the on-demand database service via user systems.

The security of a particular user system might be entirely determined by permissions (permission levels) for the current user. For example, where a user account identification transaction may involve a portable identification alpha-numeric data field physically or digitally linked to a personal primary identification device to request services from a provider account and wherein the user is using a particular user system to interact with System, that user system has the permissions allotted to that user account. However, while an administrator is using that user system to interact with System, that user system has the permissions allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different permissions with regard to accessing and modifying application and database information, depending on a user's security or permission level.

A network can be a LAN (local area network), WAN (wide area network), wireless network, point-to-point network, star network, token ring network, hub network, or another appropriate configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that the networks that the present invention might use are not so limited, although TCP/IP is a frequently implemented protocol.

User systems might communicate with a system using TCP/IP and, at a higher network level, use other common Internet protocols to communicate, such as HTTP, FTP, AFS, WAP, etc. In an example where HTTP is used, a user system might include an HTTP client commonly referred to as a “browser” for sending and receiving HTTP messages to and from an HTTP server at System. Such HTTP server might be implemented as the sole network interface between a system and network, but other techniques might be used as well or instead. In some implementations, the interface between a system and network includes load sharing functionality, such as round-robin HTTP request distributors to balance loads and distribute incoming HTTP requests evenly over a plurality of servers. At least as for the users that are accessing that server, each of the plurality of servers has access to at least one third party entity system data schema; however, other alternative configurations are contemplated.

According to one arrangement, each user system and all of its components are operator configurable using applications, such as a browser, including computer code run using a central processing unit such as an Intel Pentium.RTM. processor or the like. Similarly, a computer system (and additional instances of an enterprise database, where more than one is present) and all of their components might be operator configurable using application(s) including computer code run using a central processing unit such as an Intel Pentium.RTM. processor or the like, or multiple processor units. A computer program product aspect includes a machine-readable storage medium (media) having instructions stored thereon/in which can be used to program a computer to perform any of the processes of the embodiments described herein. Computer code for operating and configuring systems to intercommunicate and to process web pages, applications and other data and media content as described herein is preferably downloaded and stored on a hard disk, but the entire program code, or portions thereof, may also be locally stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a client system and/or server or server system such as, for example, in C, C++, HTML, any other markup language, Java.TM., JavaScript, ActiveX, any other scripting language such as VBScript, and many other programming languages as are well known. (Java.TM. is a trademark of Sun Microsystems, Inc.).

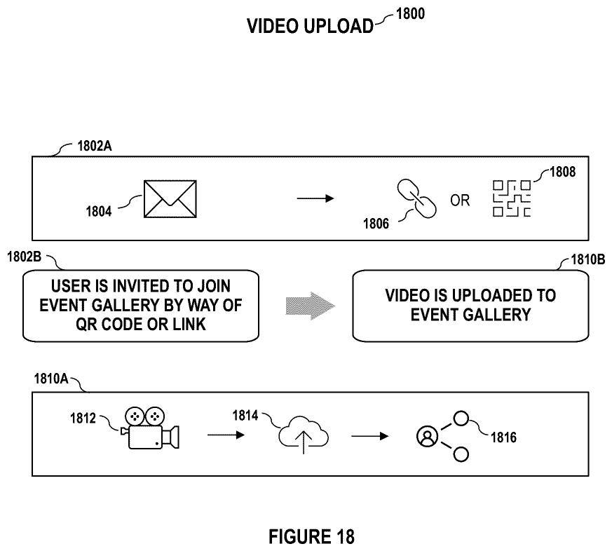

FIG. 18 is a diagram depicting the video upload iteration of the present invention. A user is invited to join an event gallery 1804 by way of a QR code 1808 or link 1806, 1802B. Then, a video 1812 is uploaded 1814 to an event gallery 1810B that is shared on a network with peers in said gallery 1816. When users receive their invites 1802A they can view all event attendees in the shared gallery 1816. Users upload their videos over a secure cloud network 1814. The diagram is split into two processes, receiving an invitation to the platform 1802A and uploading the video on to the cloud and interacting within the platform 1810A.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A system for sharing digital media in an event ecosystem, the system comprising:
a personal device, comprising a central processing unit, capable of executing computer readable instructions and a plurality of program modules;
a memory unit, in communication with an FTP server to retrieve and transmit said digital media to a cloud-based data storage medium, and wherein a web service client hosts said cloud-based data storage medium;
a unique identification marker assigned to a user;
a program module interface for said plurality of program modules presenting said digital media, and wherein said program module interface facilitates interactions between a plurality of users through a communication interface;
an editing interface, wherein said digital media is capable of being modified, edited and altered by at least one of said plurality of users with corresponding documentation of all changes to said digital media using said unique identification marker; and
a digital media encryption feature utilizing said unique identification marker assigned to said digital media, wherein said feature regulates distribution permissions among said plurality of users through said communication interface.

2. The system according to claim 1, wherein said distribution permissions are assigned clearance levels that determine a user's ability to edit or distribute an image.

3. The system according to claim 1, wherein said digital media applies a digital rights management algorithm using artificial intelligence to prevent redistribution of an image.

4. The system according to claim 3, further comprising of a content protection blackout to prevent screen captures of said digital media.

5. The system according to claim 1, wherein said program module interface enables said user to create an event album for uploading said digital media to said communication interface.

6. The system according to claim 5, wherein said user is invited to said event album using a QR code.

7. The system according to claim 5, further comprising of said event album accepts uploads of said digital media for an event's duration.

8. A method for sharing digital media in an event ecosystem, the method comprising:
executing computer-readable instructions by way of a central processing unit to present a plurality of program modules on a user's personal device;
retrieving and transmitting digital media from a memory unit, in communication with an FTP server to a cloud-based data storage medium, and wherein said cloud-based data storage media is hosted by a web service client;
assigning a unique identification marker to said user;
presenting a plurality of program modules on a program module interface to present said digital media, and wherein said program module interface facilitates interactions between a plurality of users through a communication interface;
editing and modifying said digital media on an editing interface through said program module interface;
generating documentation of all changes to said digital media using said unique identification marker corresponding to said user;
encrypting said digital media by utilizing said unique identification marker corresponding to said user and said digital media; and
managing distribution permissions of said digital media among said plurality of users through said communication interface.

9. The method according to claim 8, wherein said distribution permissions are assigned clearance levels that determine a user's ability to edit or distribute an image.

10. The method according to claim 8, wherein said digital media applies a digital rights management algorithm using an artificial intelligence analysis to prevent redistribution of an image.

11. The method according to claim 10, further comprising of a content protection blackout to prevent screen captures of said digital media.

12. The method according to claim 8, wherein said program module interface enables said user to create an event album for uploading said digital media to said communication interface.

13. The method according to claim 12, wherein said user is invited to said event album using a QR code.

14. The method according to claim 12, further comprising of said event album accepts uploads of said digital media for an event's duration.

15. A system for sharing digital media in an event ecosystem, the system comprising:
a personal device, comprising a central processing unit, capable of executing computer-readable instructions and a plurality of program modules;
a memory unit, in communication with an FTP server to retrieve and transmit said digital media to a cloud-based data storage medium, and wherein a web service client hosts said cloud-based data storage medium;
a unique identification marker assigned to a user uploading said digital media to an event album, and wherein said user is invited to said event album using a QR code;
a time limit associated with said event album to enable uploads for a designated duration corresponding to an event, further comprising of said event album accepts said uploads of said digital media for an event's duration;
a digital rights management algorithm to prevent redistribution and screen captures of said digital media;
a program module interface for said plurality of program modules presenting said digital media, and wherein said program module interface facilitates interactions between a plurality of users through a communication interface;
an editing interface, wherein said digital media is capable of being modified, edited and altered by at least one of said plurality of users with corresponding documentation of all changes to said digital media using said unique identification marker; and
a digital media encryption feature utilizing said unique identification marker assigned to said digital media, and wherein distribution permissions are determined by a clearance level allocated to said user.

16. The system according to claim 15, wherein said distribution permissions include preventing redistribution of said digital media on said program module interface and independent of said program module interface.

17. The system according to claim 15, wherein said clearance level is determined by a host of said event, including an owner of said event album.

18. The system according to claim 17, further comprising of said host disabling editing on said digital media by way of locking said digital media or only allowing metadata of said digital media to be seen.

19. The system according to claim 15, wherein said plurality of users in attendance of said event provide their consent for distribution of said digital media.

20. The system according to claim 19, further comprising of said plurality of users conducting a poll on whether said digital media may be distributed.
